(19) United States
(12) Patent Application Publication
(10) Pub. No.: US 2007/0245390 A1
(43) Pub. Date: Oct. 18, 2007

(54) Multisync image output system

(75) Inventor: Ji Sang Kwak, Seoul (KR)

Correspondence Address: MERCHANT & GOULD PC, P.O. BOX 2903, MINNEAPOLIS, MN, 55402-0903, US

(73) Assignee: INFOSQUARE CO., LTD., Seoul (KR)

(21) Appl. No.: 11/712,076

(22) Filed: Feb. 28, 2007

(30) Foreign Application Priority Data
Apr. 18, 2006 (KR) 10-2006-0035116

(51) Int. Cl. H04N 7/173; H04N 11/04

(52) U.S. Cl. 725/110; 375/240.25

(57) ABSTRACT

Disclosed is a multisync image output system in which a system manager server synchronizes each decoder on the basis of the information transmitted by each decoder that is connected to the system manager server through the network, and thus the number of the decoders can be optionally varied. According to the multisync image output system of the present invention, it is not necessary to use a plurality of multisync image boards that are expensive and have a limited number of channels. Therefore, it is possible to considerably reduce the system construction cost.

### BACKGROUND OF THE INVENTION

1. Field of the Invention

The present invention relates to a multisync image output system. More particularly, the present invention relates to a multisync image output system in which images displayed by a plurality of display devices can be output in sync without using a plurality of image boards that supports a multisync method.

2. Description of the Related Art

When corporate marketing promotion images are displayed by one display device (for example, an LCD monitor, a PDP monitor, a CRT, and the like) in a technical EXPO, an industry exhibition, and the like, resolution of the images is restricted because one display device is used. As a result, it is impossible to efficiently and clearly display corporate marketing promotion images.

Accordingly, a multisync image output system (so-called multivision) has been developed in which large-sized images having high resolution are displayed by connecting a plurality of display devices so as to effectively display corporate marketing promotion images.

In this multisync image output system, multiimages displayed by the plurality of display devices need to be in sync. For this reason, according to the related art, a system has been used in which an image board for multisync that makes images from multiple channels in sync is mounted in a PC or a set-top box to output images.

However, the above-described image board for multisync is relatively expensive, while the number of channels, which is applied to the image board for multisync, is restricted (approximately, four channels).

Accordingly, according to the related art, since a plurality of image boards for multisync need to be used in order to implement a large-scaled multisync image output system, the system construction cost is very high. Further, after the system is constructed, it is difficult to increase or decrease the number of display devices, which lowers a degree of freedom in layout of displays.

### SUMMARY OF THE INVENTION

Accordingly, an object of the present invention is to provide a multisync image output system in which it is not necessary to use a plurality of expensive image boards for multisync, and the number of display devices can be optionally increased or decreased.

In order to accomplish the above objects, the present invention provides a multisync image output system, which includes a plurality of display devices, a set-top box including a plurality of image decoders that are connected to the plurality of display devices, respectively, and a system manager server that is connected to the set-top box through a network wherein the set-top box transmits image decoding location values and image bit rates for each image decoder to the system manager server, and the system manager server compares the image decoding location values and the image bit rates transmitted by the set-top box, generates an image decoding location correcting value for an image decoder that is out of sync, and transmits the image decoding location correcting value to the set-top box.

In this structure, preferably, the system manager server divides each image decoding location value by a corresponding image bit rate so as to calculate an image output time for each image decoder, subtracts an output time of an image decoder whose image output time is later than a reference image output time from the reference image output time using an image output time of an image decoder whose image output time is earliest as the reference image output time, and calculates the image decoding location correcting value by multiplying the subtracted value by a bit rate of the image decoder whose image output time is later than the reference image output time.

### BRIEF DESCRIPTION OF THE DRAWINGS

The above and other features and advantages of the present invention will become more apparent by describing in detail preferred embodiments thereof with reference to the attached drawings in which:

FIG. 1 is a diagram illustrating a schematic structure of a multisync image output system according to an embodiment of the present invention; and

FIG. 2 is a diagram illustrating a detailed structure of a multisync image output system shown in FIG. 1.

### DESCRIPTION OF THE PREFERRED EMBODIMENTS

Hereinafter, a detailed description will be given of a multisync image output system according to an embodiment of the present invention with reference to the accompanying drawing.

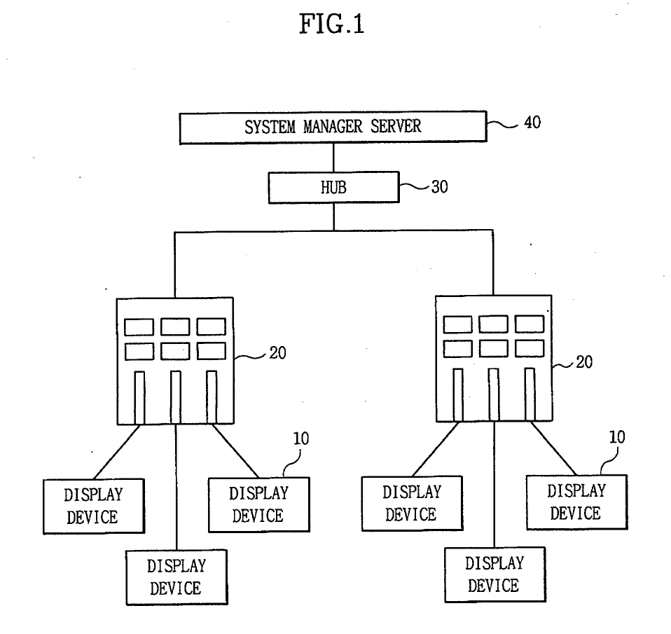

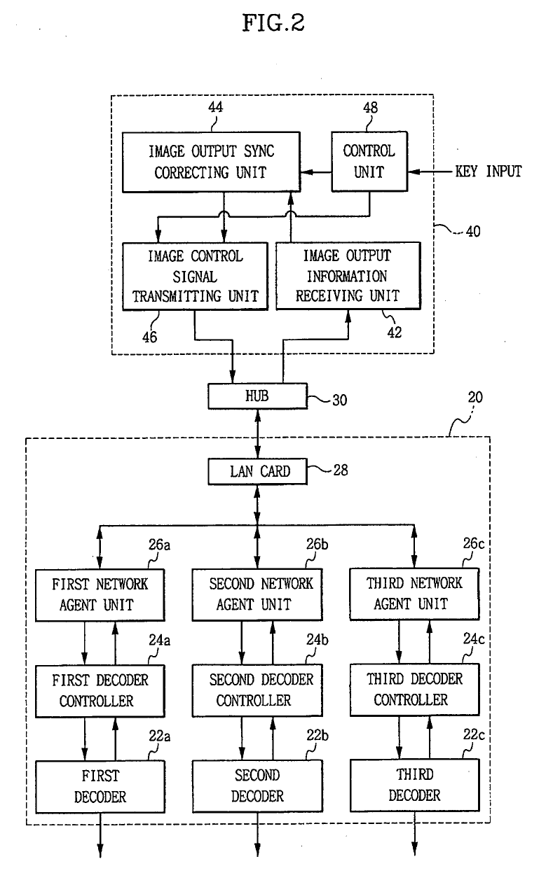

FIG. 1 is a diagram illustrating a schematic structure of a multisync image output system according to an embodiment of the present invention, and FIG. 2 is a diagram illustrating a detailed structure of FIG. 1.

A multisync image output system according to an embodiment of the present invention includes a plurality of display devices 10, set-top boxes 20 each of which includes a plurality of image decoders that are connected to the plurality of display devices 10, respectively, and a system manager server 40 that is connected to the set-top boxes 20 through a network.

In this case, each display device 10 is a terminal, such as an LCD monitor, a PDP monitor, a CRT monitor, and the like, which can output images.

In addition, the respective display devices 10, and the image decoders of the set-top boxes 20 are connected to each other by video signal cables (for example, RGB cables, component cables, DVI cables, S/Video cables, and the like).

A hub 30 may be used as network equipment for data communication between the set-top box 20 and the system manager server 40. The hub 30 and the set-top box 20 communicate with each other by using a protocol, such as TCP/IP or a UDP.

The set-top box 20 transmits image decoding location values and image bit rates in the respective decoders to the system manager server 40.

The system manager server 40 analyzes all of the image decoding location values and the image bit rates that have been received, transmits to the set-top box 20, an image decoding location correcting value of a decoder where an image decoding location correcting operation needs to be performed, and transmits an image output control signal to the set-top box 20 according to an image output pattern selecting signal input through a key operation by a user from the outside.

In this invention, the following three image output patterns are used. Specifically, in the first image output pattern, in order to display screens of the plurality of display devices 10 as one screen, images of the plurality of screens are displayed on one screen. In the second image output pattern, the plurality of display devices 10 are divided into groups, and a different image is displayed for each group. In the third image output pattern, a different image is displayed for each of the plurality of display devices 10.

Therefore, the image output pattern selecting signal input by the user refers to a signal indicating that an arbitrary image output pattern is selected from among various image output patterns that can be selected by the user. The three image output patterns have been exemplified, but the present invention is not limited thereto. The number of the image output patterns may be three or more.

The set-top box 20 includes first to third decoders 22a, 22b, and 22c, first to third decoder controllers 24a, 24b, and 24c, and first to third network agent units 26a, 26b, and 26c. In this case, each of the first to third decoders 22a, 22b, and 22c is a type of a card (for example, PCI card) where a video codec chip is embedded. The first to third decoder controllers 24a, 24b, and 24c are connected to the respective first to third decoders 22a, 22b, and 22c, and output images decoding location values and image bit rates of the corresponding respective decoders. The first to third network agent units 26a, 26b, and 26c are connected to the respective first to third decoder controllers 24a, 24b, and 24c, transmit the image decoding location values and the image bit rates output from the corresponding respective decoder controllers to the system manager server 40 through the hub 30, and transmit the image output control signals output from the system manager server 40 to the corresponding respective decoder controllers.

For example, the first to third decoders 22a, 22b, and 22c may be configured such that they can support output of a high-definition (HD) image (1920 pixels*1080 pixels) and decode an image compressed by using a high-definition video compression format (for example, MPEG 2 or the like).

In addition, a LAN card 28 is provided in the set-top box 20 such that data communication can be performed between the first to third network agent units 26a, 26b, and 26c, and the hub 30.

The first to third decoder controllers 24a, 24b, and 24c control the corresponding respective decoders.

Each of the first to third decoder controllers 24a, 24b, and 24c receives a command of a corresponding network agent unit, controls image output start and completion time points, movement of an image output location, and an image output speed for a decoder to be controlled, and transmits an image decoding location value and an image bit rate of the corresponding decoder to the corresponding network agent unit at predetermined time intervals or in real time.

Further, when a failure occurs in the decoders to be controlled, each of the first to third decoder controllers 24a, 24b, and 24c transmits an error occurrence indicating signal to a corresponding network agent unit, and initializes the corresponding decoder to be automatically restored.

The first to third decoder controllers 24a, 24b, and 24c read the number of bytes of image files that have been output till then and are stored in memory buffers (not shown) of the corresponding respective decoders 22a, 22b, and 22c, and recognize location values that are currently being decoded (that is, image decoding location values).

In FIG. 2, the number of decoders is three, but three or more decoders may be provided. If the number of decoders is four or more, the number of decoder controllers and the number of network agent units are adjusted to be equal to the number of decoders.

In FIG. 1, the two set-top boxes 20 are connected to the hub 30 in order to simplify a structure of the drawing, but the present invention is not limited thereto. Therefore, set-top boxes of three or more may be connected to the hub 30.

In this invention, reference numeral 20 indicates the set-top box. However, the set-top box 20 may be a set-top box that is any one of the known various shapes of set-top boxes, and a set-top box of a new shape that did not exist until now.

Further, in this invention, for enhancement of understanding, the set-top box is indicated by the reference numeral 20. Furthermore, the set-top box may be substituted by a PC or a data communication apparatus, as long as it can perform data communication with the system manager server 40 through the hub 30.

Furthermore, in this invention, since an image source that provides an image signal to each set-top box corresponds to a generally well-known technology, it is not specifically shown. For reference, if the image source is exemplified for better understanding of those skilled in the art, the image source may be a DVD player, a CD player, a VCR, a computer terminal, and the like.

The system manager server 40 includes an image output information receiving unit 42, an image output sync correcting unit 44, an image control signal transmitting unit 46, and a control unit 48. The image output information receiving unit 42 receives image decoding location values and image bit rates input through the hub 30. The image output sync correcting unit 44 compares image decoding location values and image bit rates for respective decoders received through the image output information receiving unit 42, generates an image decoding location correcting value for an image decoder that is out of sync, and outputs it. The image control signal transmitting unit 46 transmits the image decoding location correcting values output from the image output sync correcting unit 44 to the set-top box 20 through the hub 30. The control unit 48 controls the image control signal transmitting unit 46 to transmit an image output control signal to the set-top box 20 according to an image output pattern selecting signal input through a key operation.

In the drawings, a memory where image data for corporate marketing promotion is stored and an image signal processing unit that reads and reproduces the image data stored in the memory are not shown. However, it can be understood by those skilled in the art that the memory and the image signal processing unit are provided in the system manager server 40. If necessary, the memory and the image signal processing unit may be provided in the decoders 22a, 22b, and 23c, and the decoder controllers 24a, 24b, and 24c. The image data that is stored in the memory can be updated.

Then, the operation of the multisync image output system according to the embodiment of the present invention will be described below. In the description below, it is assumed that a user selects the first image output pattern in which a large-sized image is displayed by the plurality of display devices 10.

If the system manager server 40 generates a sync start signal and transmits the sync start signal to the set-top box 20 though the hub 30, the first to third network agent units 26a, 26b, and 26c in the set-top box 20 receive the sync start signal.

Each of the first to third network agent units 26a, 26b, and 26c transmits the sync start signal to a corresponding decoder controller among the first to third decoder controllers 24a, 24b, and 24c.

Therefore, the first to third decoder controllers 24a, 24b, and 24c that have received the sync start signal control the corresponding respective decoders 22a, 22b, and 22c to start image output from the beginning, check decoding location values and bit rates of images that are being decoded by the respective decoders 22a, 22b, and 22c, and transmit them to the first to third network agent units 26a, 26b, and 26c at a predetermined time interval or in real time.

When the first to third decoder controllers 24a, 24b, and 24c transmit the image decoding location values to the corresponding respective first to third network agent units 26a, 26b, and 26c, they also transmit identification information for indicating that the transmitted image decoding location values are from which decoder controllers or for which decoders.

The first to third network agent units 26a, 26b, and 26c transmit the received image decoding location values to the system manager server 40 through the LAN card 28 and the hub 30, respectively.

The image output information receiving unit 42 of the system manager server 40 receives the image decoding location values and the image bit rates and transmit them to the image output sync correcting unit 44, and the image output sync correcting unit 44 compares the image decoding location values and the image bit rates for the respective image decoders that have been received, generates an image decoding location correcting value for a decoder that is out of sync, and outputs the image decoding location correcting value.

In this case, the image output sync correcting unit 44 divides a decoding location value of each image by a bit rate of the corresponding image so as to calculate an image output time for each image decoder, subtracts an output time of an image decoder whose image output time is later than a reference image output time from the reference image output time using an image output time of an image decoder whose image output time is earliest as the reference image output time, and calculates the image decoding location correcting value by multiplying the subtracted value by a bit rate of the image decoder whose image output time is later than the reference image output time.

That is, when image output times are different from one another among the respective decoders, the respective decoders are out of sync. In this case, the image output times of the other image decoders are matched with the image output time of the decoder whose image output time is earliest.

A method of calculating the image decoding location correcting value is summarized as the following Equations. In this case, it is assumed that there are a pair of decoders called “A” and “B”, respectively.

(1) First, the image output time is defined by Equation 1.

Image output time=image decoding location value of image/bit rate of image [Equation 1]

That is, the image output sync correcting unit 44 divides a decoding location value of each image by a bit rate of the corresponding image so as to calculate an image output time for each decoder.

(2) When an image output time of A is matched with an image output time of B, that is, when A and B are in sync, the following Equation 2 is realized.

Image output time of A=image output time of B [Equation 2]

Equation 2 can be summarized in Equation 3 by using Equation 1.

Image decoding location value of A/image bit rate of A=image decoding location value of B/image bit rate of B [Equation 3]

(3) When an image output time of A is not matched with an image output time of B but the image output time of A is earlier than the image output time of B, a correction value that matches the image output time of B with the image output time of A can be calculated by Equation 4 that is derived from Equation 1 to 3.

Image decoding location correcting value of B

=(image output time of A−image output time of B)*image bit rate of B

={(image decoding location value of A/image bit rate of A)−(image decoding location value of B/image bit rate of B)}*image bit rate of B [Equation 4]

When the image output sync correcting unit 44 transmits the image decoding location correcting value, it also transmits identification information for indicating that the transmitted image decoding location correcting value is used by which decoder controllers. In addition, when a decoder that is out of sync does not exist, the image output sync correcting unit 44 transmits to the image control signal transmitting unit 46, a signal indicating that all of the received image decoding location values are normal.

The image control signal transmitting unit 46 transmits the information (that is, signals indicating the image decoding location values or that all of the image decoding location values are normal) transmitted from the image output sync correcting unit 44 to the set-top box 20 through the hub 30.

When the image decoding location correcting values are transmitted by the image control signal transmitting unit 46, the image decoding location correcting values are transmitted to the network agent units, which are connected to the decoders where the image decoding location correcting values are necessary, through the LAN card 28 of the set-top box 20, and are then input to the corresponding decoder controllers.

Then, the decoder controller that receives the corresponding image decoding location correcting value adjusts an image decoding location in the corresponding decoder.

In this way, the images output by the plurality of display devices 10 are displayed on one screen.

In addition, according to the setting of the user, the images may be displayed on a plurality of separated screens without displaying the images on one screen, which is not described in detail therein because it can be understood by those skilled in the art.

As described above, in the multisync image output system according to the embodiment of the present invention, the system manager server calculates an image output time for each decoder on the basis of the information reported from each decoder connected to the system manager server through the network, and synchronizes the other decoders whose image output time is later than the decoder whose image output time is earliest. Therefore, the number of decoders may optionally be varied.

For example, in the case of when after a multivision is constructed in which images are displayed through forty display devices, twenty display devices are additionally provided, if twenty display devices and twenty decoders are additionally provided and are connected to the system manager server through the network, the system manager server synchronizes all of the decoders on the basis of the information transmitted by the sixty decoders. Therefore, it is possible to construct a multisync image output system in which a large-scaled multisync screen can be displayed without changing a basic structure of the already constructed system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

In the multisync image output system according to the embodiment of the present invention, the system manager server synchronizes each decoder on the basis of the information transmitted by each decoder that is connected to the system manager server through the network. Therefore, the number of decoders can be optionally varied.

Further, it is not necessary to use a plurality of multisync image boards that are expensive and have a limited number of channels. Therefore, it is possible to considerably reduce the system construction cost.

What is claimed is:

1. A multisync image output system, comprising:
a plurality of display devices;
a set-top box including a plurality of image decoders that are connected to the plurality of display devices, respectively; and
a system manager server that is connected to the set-top box through a network,
wherein the set-top box transmits image decoding location values and image bit rates for each image decoder to the system manager server, and
the system manager server compares the image decoding location values and the image bit rates transmitted by the set-top box, generates an image decoding location correcting value for a decoder that is out of sync, and transmits the image decoding location correcting value to the set-top box.

2. The multisync image output system as set forth in claim 1, wherein the set-top box includes:
a plurality of decoder controllers, each of which is connected to each image decoder, outputs an image decoding location value and an image bit rate of the corresponding image decoder, and corrects a location of an image decoded by each image decoder on the basis of the image decoding location correcting value received from the system manager server; and
a plurality of network agent units, each of which is connected to each decoder controller, transmits an image decoding location value and an image bit rate input from each decoder controller to the system manager server through the network, and transmits the image decoding location correcting value received from the system manager server to a corresponding decoder controller.

3. The multisync image output system as set forth in claim 1, wherein the system manager server includes:
an image output information receiving unit that receives image decoding location values and image bit rates for the respective image decoders that are input through the network;
an image output sync correcting unit that compares the image decoding location values and the image bit rates for the respective image decoders having been received by the image output information receiving unit, generates an image decoding location correcting value for a decoder that is out of sync, and outputs the image decoding location correcting value; and
an image control signal transmitting unit that transmits the image decoding location correcting value output by the image output sync correcting unit to the set-top box through the network.

4. The multisync image output system as set forth in claim 1, wherein the system manager server divides each image decoding location value by a corresponding image bit rate so as to calculate an image output time for each image decoder, subtracts an output time of a decoder whose image output time is later than a reference image output time from the reference image output time using an image output time of an image decoder whose image output time is earliest as the reference image output time, and calculates an image decoding location correcting value by multiplying the subtracted value by a bit rate of the image decoder whose image output time is later than the reference image output time.

5. The multisync image output system as set forth in claim 3, wherein the image output sync correcting unit of the system manager server divides each image decoding location value by a corresponding image bit rate so as to calculate an image output time for each decoder, subtracts an output time of an image decoder whose image output time is later than a reference image output time from the reference image output time using an image output time of a decoder whose image output time is earliest as the reference image output time, and calculates an image decoding location correcting value by multiplying the subtracted value by a bit rate of the image decoder whose image output time is later than the reference image output time.

6. The multisync image output system as set forth in claim 1, wherein a plurality of set-top boxes are provided.
